(19) United States
(12) Patent Application Publication
(10) Pub. No.: US 2003/0182243 A1
(43) Pub. Date: Sep. 25, 2003

(54) Method and apparatus for remote control of electronically activated tasks

(76) Inventors: Howard J. Gerson, Overland Park, KS (US); Jon E. Price, Overland Park, KS (US); Chuck Tooley, Kansas City, KS (US); Michael M. Davis, Westwood, KS (US)

Correspondence Address: LATHROP & GAGE LC, 2345 GRAND AVENUE, SUITE 2800, KANSAS CITY, MO, 64108, US

(21) Appl. No.: 10/103,587

(22) Filed: Mar. 20, 2002

(51) Int. Cl. H04Q 1/00

(52) U.S. Cl. 705/73; 340/5.42; 340/825.72

(57) ABSTRACT

The present invention is directed to an apparatus and method for conducting delegated tasks in response to a remote signal. The apparatus includes terminals, such as coin-operated electronic apparatus or consumer electronic apparatus, that are equipped with a module having a controller component configured to transfer and receive telephonic and data commands to activate a function of the terminal remotely and monitor certain conditions within the terminal. The method comprises the steps of accessing an electronic communication device of the terminal through a communication device of the user (i.e. mobile phone, PDA, etc.), a module receiving, authenticating and executing the command inputted at the user's communication device in response to the command and, optionally, monitoring the functions of the terminal and communicating a related signal to an associated data network.

### BACKGROUND OF THE INVENTION

1. Field of the Invention

The present invention relates to a method and apparatus for conducting various delegated tasks in real time in response to a remote data command. More specifically, the present invention relates to a method and apparatus for executing electronically activated tasks in real time through a remote data command.

2. Description of the Related Art

Remote control systems are known for activating a command on certain user-owned and user-controlled electronic devices when the user is remote from the device, such as, for examples, televisions, stereos, and garage door openers. However, current remote control designs are impractical to use with electronic apparatus not owned or controlled by the user, such as, vending machines. It would be advantageous for a personal communication device, such as a cellular telephone or personal digital assistant (PDA), to serve as the remote control system for such electronic apparatus. In this way, cellular telephones or PDA-type devices could be used to, for example, conduct an electronic money transaction with a vending machine to dispense a product, or to initiate a wash cycle on a laundry machine.

From a consumer perspective, the use of coinage or paper bills to purchase products or operate pay-for-service machines is often cumbersome and inconvenient. For example, the user may not, before arriving at the vending location, be aware of the cost of items in the machine or have the correct amount of money to pay for those specific items. Further, most machines only accept paper bills that are in a relatively untattered condition. Coinage is burdensome since the coins required for larger purchases are space-consuming and heavy. Additionally, the transaction costs of credit or debit card transactions is prohibitive in many small purchase applications.

U.S. Application Serial No. 60/277,398, entitled A Method and Apparatus for Executing Tasks Remotely, which is commonly owned by the assignee of the subject application and is incorporated herein by reference, provides a method and apparatus that facilitates the use of electronic devices through a communication system. In this way, the communication system enables a user to access the functions of an electronic device and initiate control commands by providing input on the communication device.

It would be advantageous to provide a method and apparatus for increased control and monitoring capabilities of various electronic devices from a nearby or remote location, specifically for conducting payment transactions on vending machines and/or pay-for-service machines without the need of coinage or credit/debit cards.

### SUMMARY OF THE INVENTION

The present invention provides a module in communication with a vending or pay-for-service machine or terminal, such as a coin-operated electronic machine. The terminal is equipped with a module that comprises a controller component, a communication component for communicating with a data network, a local access component for communication with the personal communication device of the user, a product/service selector component for communication with the terminal's drive apparatus, and interfaces to a multi-drop bus for control and monitoring of the terminal.

The controller component includes a microprocessor running programs consisting of commands that are stored in non-volatile memory. The data network, personal communication device, and/or the local access component are used to communicate desired terminal functions between the user and the controller component. The controller component receives data from one of the communication component and the local access component and processes the signals. The controller component commands the desired functions through the product/service selector component for associated action.

In an embodiment of the present invention directed to vending, the terminal further includes an inventory service component that communicates with the controller component to re-set the inventory tracking features to a “serviced mode”, and interfaces with a control bus and DEX/UCS component to access inventory management information stored therein.

An exemplary method for using the apparatus of the present invention in the vending embodiment with a mobile telephone includes establishing an account with the network through cash prepayment, credit card or debit card funding, or transfer from some other financial account. The terminal user initiates the transaction by connecting to the network through a personal communication device and accessing its host services, which authenticates the user. If authenticated, the selection prompts are provided to the user and the user selects a desired product. Upon selection, the network establishes communication with the communication component of the terminal, determines whether the user has sufficient funds to enact the transaction and provides data for authorizing the transaction at the terminal. The controller component credits the multi-drop bus with an amount for the transaction and the product selector vends the selected product. The controller component, through the communication component informs the network of the success or failure of the vend, and, if success, the amount vended.

An exemplary method for using the apparatus of the present invention in the vending embodiment with a PDA includes establishing an account with the network and downloading a vend program on the PDA. The user accesses the vend program and enters the user's pre-established personal identification number. The user selects a product from the menu provided on the PDA. The PDA communicates the selection directly with the local access controller, which communicates with the controller component. The controller component communicates the network to determine the account sufficiency, if sufficient, the controller component communicates with the product selector to vend a particular item. The product selector vends the selected product. The controller component, through the communication component informs the network of the success or failure of the vend, and, if success, the amount vended.

Accordingly, the present invention provides a method of remotely initiating a response from a terminal through a personal communication device and monitoring the status of the terminal.

### BRIEF DESCRIPTION OF THE DRAWINGS

The invention, together with further objectives and advantages thereof, may best be understood by reference to the following description taken in conjunction with the accompanying drawings in which:

FIG. 1 is a block diagram of the module.

FIGS. 2A and 2B are flow diagrams illustrating the operation of the main routine in a vending application in accordance with the present invention.

FIG. 3 is a diagram showing the communication pathway from a personal communication device of a user to the terminal.

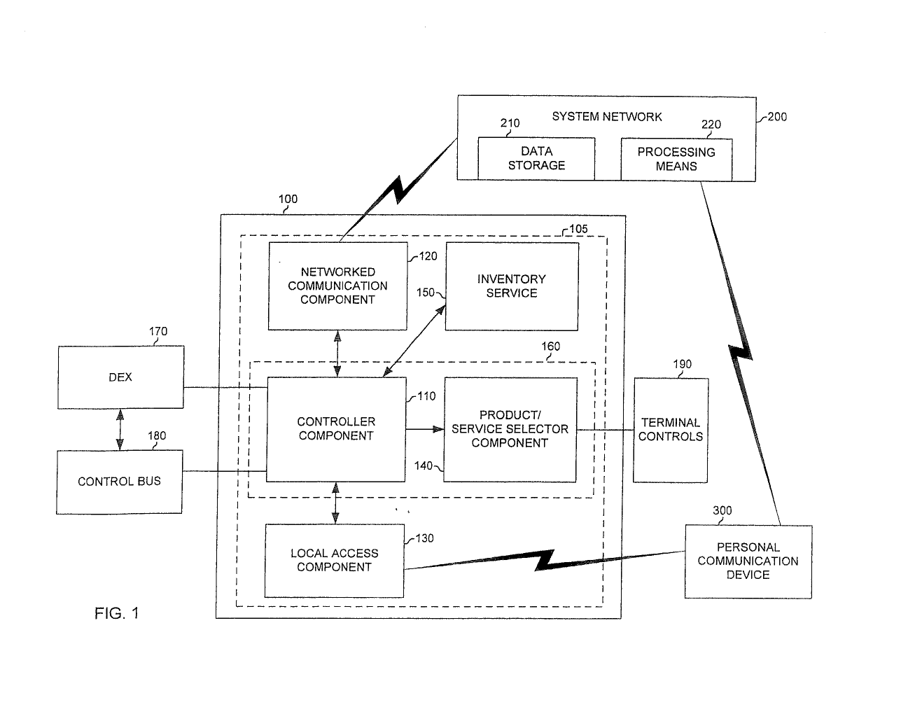

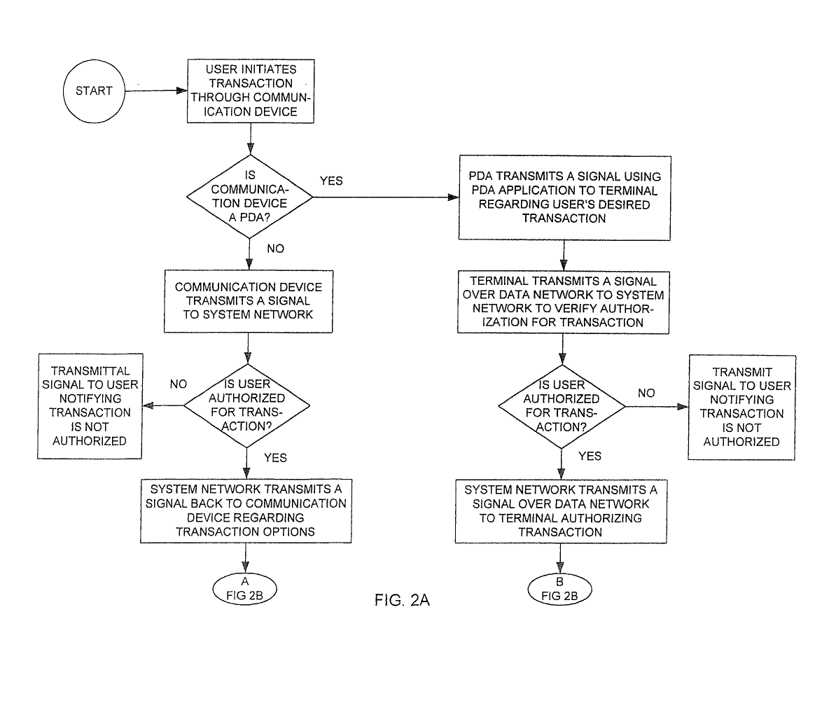

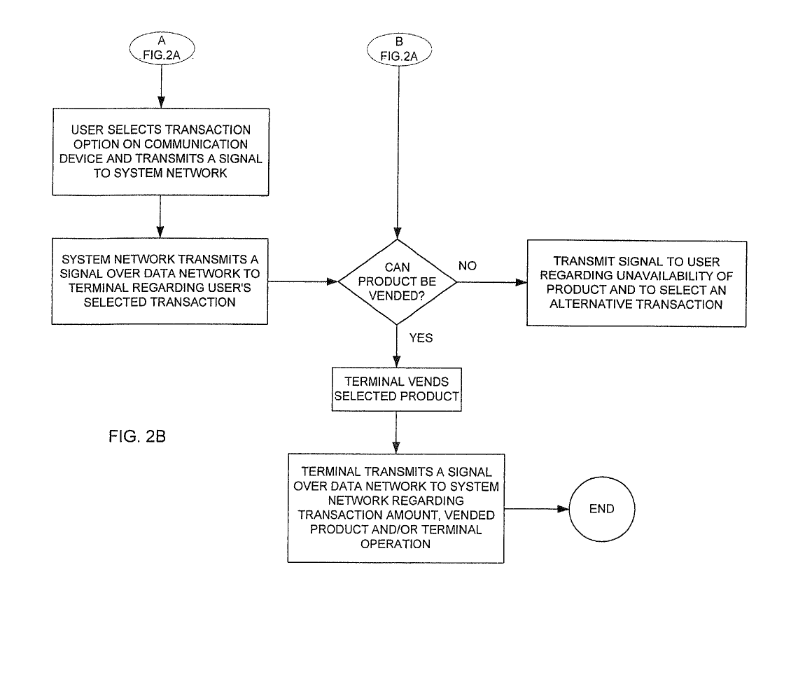

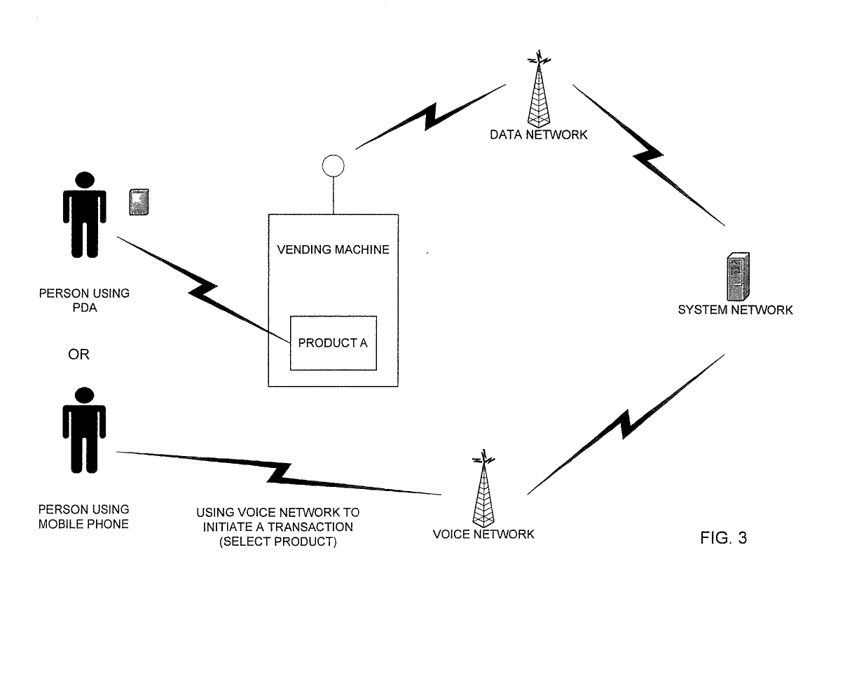

### DETAILED DESCRIPTION OF THE PREFERRED EMBODIMENTS

The present invention discloses an apparatus and a method for controlling electronically activated tasks on terminals through a remote command and for monitoring the terminal. The apparatus of the present invention comprises terminals, indicated generally at 100, equipped with a module 105 capable of transferring and receiving data commands to activate a function of the terminal and monitor certain conditions within the terminal.

The terminals 100 are coin-operated electronic devices or consumer electronic devices that require the user to be near the apparatus to initiate the apparatus and select the desired function for the device. For example, terminals may be parking meters, light systems, alarm systems, dishwashing machines. In one exemplary embodiment, the terminal is an electronically controlled vending or pay-for-service type machine that requires a payment transaction to vend a product or perform a function.

The terminal 100 is provided with a module 105 that comprises a controller component 110, a communication component 120 for communicating with a data network 200, a local access component 130 for communication with the personal communication device 300 of the user, a product/service selector component 140 for communication with the terminal's motor or other terminal controls 190, an interface to a multi-drop bus 180 for control and monitoring of the terminal, and in the vending embodiment, an interface with a DEX/UCS component 170 for accessing the vending history of the electronically controlled machines.

The controller component 110 includes processing means, which comprises a microprocessor running programs consisting of commands that are stored in non-volatile memory. The data network 200, personal communication device 300, and/or the local access component 130 are used to communicate the desired terminal functions between the user and the controller component 110, as will be described in greater detail hereinafter. The controller component 110 receives data from the communication component 120 and/or the local access component 130 and processes the signals through a micro-controller. The controller component 110 commands the user-selected functions through the product/service selector component 140 to the solid state relays and switches, or motor controls, that are connected to the electromechanical device or machine for associated action.

The module communicates with the network 200 through the communication component 120. The communication component 120 enables network 200 connectivity between the controller component 110 and the network 200 to access the host services of the network 200. The communication component 120 can interact with any communication network and corresponding protocol. Current embodiments, for example, are specific to DataTac, Mobitex, IDEN, or Ethenet networks. It is to be understood by those skilled in the art that the communication component 120 can be modified to interact with other communication networks and protocols without departing from the scope of the present invention.

The local access component 130 enables front-end communication with the user's communication devices. In an exemplary embodiment, the local access component 130 transmits to and accepts IrDA communications from the personal communication device 300 of the user. It is to be understood that Blue-Tooth or Wi-Fi may be used without departing from the scope of the invention. The local access component 130 is operable with a user's PDA to effectuate control of the electronic activated task.

The product/service selector component 140 receives commands from the controller component 110 and, in response activates the desired functionality in the terminal. In a retrofit application of the vending embodiment, the product/service selector component 140 comprises an opto-isolated relay control board and wiring harness. In response to a signal from the controller component 110, this relay control board and wiring harness by-passes the vending control board of terminal and actuates the driving motor 190 or other desired function control mechanism of the apparatus to perform the delegated task. Alternatively, the controller component 110 and product/service selector component 140 is firmware configured to control the terminal to respond to a remote data command. In this embodiment, the firmware is provided on the vending control board for the terminal and, in response to data from the communications or local access component 130, actuates the driving motor 190 or other desired function control mechanism of the apparatus to perform the delegated task.

In the vending embodiment, the controller component 110 interfaces with the multi-drop bus 180 (MDB) for the terminal. The controller component 110 polls the MDB 180 for peripheral activity and the MDB 180 responds with specific data dependent on its pre-determined activity. Peripherals for the MDB 180 include the coin mechanism, bill validater, credit/debit card reader.

In the vending embodiment, the controller component 110 further interfaces with the DEX/UCS component 170 of the terminal. The DEX/UCS component 170 stores inventory management information that is then accessible by the network 200 through the controller and communication components 120. The inventory service component communicates with the controller component 110 to reset the inventory tracking features to a “serviced mode.”

As an additional functionality, the controller component 110 is provided with a hand-shaking communication protocol between the microprocessor and the network 200.

In operation, an exemplary method for using the apparatus in the vending embodiment includes the following steps. The method differs if the personal communication device 300 is a mobile telephone or a Personal Digital Assistant (PDA). For mobile phone users, an interested user establishes an account with the network 200, as described in co-pending application Ser. No. 09/587,154, entitled Method and Apparatus for Wireless Telephony payment, and incorporated herein by reference. The account is funded through cash prepayment, credit card or debit card funding, or transfer from some other financial account. The terminal user initiates the transaction by connecting to the network 200 and accessing its host services. The network 200 verifies whether the user is an authorized user by authenticating the user through existing caller ID technology (CID) or through voice-recognition technology for the mobile unit user. If authenticated, the selection prompts are provided to the user.

Upon selection by the consumer on the mobile telephone, the network 200, through the hand-shaking protocol, establishes communication with the communication component 120 of the terminal, determines whether the user has sufficient funds to enact the transaction and provides data for authorizing the transaction at the terminal. In response to this transmitted data from the network 200, the controller component 110 credits the MDB 180 for the terminal with an amount for the transaction and communicates with the product/service selector component 140 to actuate the selected functionality (i.e., vend a particular item). The product/service selector component 140 activates the terminal's control mechanism, such as vend motor 190, to perform the desired functionality. The controller component 110, through the communication component 120 informs the network 200 of the success or failure of the transaction, and, if success, the data surrounding the transaction. The DEX/UCS component 170 of the terminal stores the quantity vended, and can be selectively polled for inventory management.

For a PDA user, an account with the network 200 is pre-established, as described in co-pending application Ser. No. 09/587,154, entitled Method and Apparatus for Wireless Telephony payment, and incorporated herein by reference. The account number and a vend program are stored in memory on the PDA. The user accesses the vend program and enters the user's pre-established personal identification number to authenticate the user. The user makes a product selection on the PDA, which communicates which communicates with the controller component 110 through the local access component 130. The controller component 110 communicates through the communication component 120 of the module through a hand-shaking protocol with the host services to determine the account balance. If sufficient, the controller component 110 communicates with the product selector to vend a particular item. The product selector vends the selected product. The controller component 110, through the communication component 120 informs the network 200 of the success or failure of the vend, and, if success, the amount vended. The DEX/UCS component 170 stores the quantity vended and can be selectively polled for inventory management.

While various embodiments of the invention have been illustrated and described, many changes can be made thereto without departing from the spirit and scope of the invention. Accordingly, the scope of the invention is not limited by the disclosure of the embodiments described herein. Instead, the scope of the invention should be determined by reference to the claims that follow.

What is claimed is:

1. An apparatus for conducting electronically activated tasks in response to a remote signal from a personal communication device of a user, the apparatus comprising:
a communication component for transferring and receiving data commands;
a controller component in communication with the communication component and having processing means responsive to the data commands received by the communication component and memory means for storing multiple functions for the terminal; and
a selector component responsive to the controller component for initiating a function of the terminal in response to the data commands wherein the remote signal is generated from the personal communication device to remotely activate the electronically activated task.

2. The apparatus of claim 1 wherein the terminal is a payment-activated electronic apparatus.

3. The apparatus of claim 2 further comprising an interface with a multi-drop bus for communicating data to the terminal.

4. The apparatus of claim 1 wherein the apparatus further includes a remote network, the network receiving data commands from the personal communication device and communicating the data commands to the communication component.

5. The apparatus of claim 4 wherein the apparatus further comprises an interface with a DEX/UCS component, the DEX/UCS component being a repository of stored terminal data, the DEX/UCS component being in communication with the controller component for relaying the stored data of the transaction to the network.

6. The apparatus of claim 4 wherein the communication component transmits and receives remote transaction specific data from the remote network in real time.

7. The apparatus of claim 4 wherein the personal communication device is a mobile telephone.

8. The apparatus of claim 1 wherein the personal communication device is a personal digital assistant, and wherein the apparatus further comprises a local access component for transferring and receiving data commands from the personal digital assistant.

9. The apparatus of claim 8 wherein the apparatus further includes a network, the communication component transmits and receives data from the network.

10. The apparatus of claim 8 wherein the local access component and the communication component operate in real-time.

11. The apparatus of claim 1, wherein the apparatus is a vending machine and wherein vending machine further includes an inventory service component, the inventory service component communicating with the controller component to identify the inventory status of the terminal.

12. An apparatus for conducting electronically activated tasks in response to a remote signal from a personal communication device of a user, the apparatus comprising:
a communication component for transferring and receiving data commands; and
a controller and selector component in communication with the communication component, the controller and selector component being firmware and having processing means responsive to the data commands received by the communication component, and memory means for storing multiple functions for the terminal, the controller and selector component being operably configured to initiate a function of the terminal in response to the data commands wherein the remote signal is generated from the personal communication device to remotely activate the electronically activated task.

13. The apparatus of claim 12 wherein the terminal is a payment-activated electronic apparatus.

14. The apparatus of claim 13 further comprising an interface with a multi-drop bus for communicating data to the terminal.

15. The apparatus of claim 12 wherein the apparatus further includes a remote network, the network receiving data commands from the personal communication device and communicating the data commands to the communication component.

16. The apparatus of claim 15 wherein the apparatus is a vending machine and wherein the apparatus further comprises an interface with a DEX/UCS component, the DEX/UCS component being a repository of stored terminal data, the DEX/UCS component being in communication with the controller component for relaying the stored data of the transaction to the network.

17. The apparatus of claim 15 wherein the communication component transmits and receives remote transaction specific data from the remote network in real time.

18. The apparatus of claim 12 wherein the personal communication device is a mobile telephone.

19. The apparatus of claim 12 wherein the personal communication device is a personal digital assistant, and wherein the apparatus further comprises a local access component for transferring and receiving data commands from the personal digital assistant.

20. The apparatus of claim 19 wherein the apparatus further includes a network, the communication component transmits and receives data from the network.

21. The apparatus of claim 19 wherein the local access component and the communication component operate in real-time.

22. The apparatus of claim 12, wherein the apparatus is a vending machine and wherein vending machine further includes an inventory service component, the inventory service component communicating with the controller component to identify the inventory status of the terminal.

23. A method for remotely initiating a response from a terminal through a remote communication device, the method comprises the steps of:
accessing a communication of the terminal through a personal communication device;
providing menu options on the personal communication device corresponding to options for the terminal;
receiving signals from the personal communication device responsive to the provided options;
executing the commands in a controller component corresponding to the signal received from the personal communication device; and
actuating a function of the terminal in response to the command received from the personal communication device.

24. The method of claim 23 further comprising the steps of:
accessing a remote network have a money account stored therein corresponding to a particular user; and
effectuating a payment from the money account through the personal communication device.

25. The method of claim 24, wherein the step of receiving signals from the personal communication device further includes the steps of:
authentication that the user is a valid user of the money account; and
sending a signal from the network to the communication component of the terminal, the signal including data regarding authorization to effectuate the task.

26. The method of claim 23 further including the step of:
monitoring the history of the terminal by polling an interface of the terminal.

27. The method of claim 23 wherein the personal communication device is a personal digital assistant, and wherein the step of accessing an electronic communication device of the terminal through a personal communication device comprises using a personal digital assistant to access a local access component of the terminal.

28. The method of claim 26 wherein the terminal is a payment-activated electronic apparatus and the step of monitoring the function of the terminal comprises monitoring the function of the terminal by the network communicating with a DEX/UCS component of the terminal.
